(19) United States
(12) Patent Application Publication
(10) Pub. No.: US 2003/0174243 A1
(43) Pub. Date: Sep. 18, 2003

(54) Network streaming system for providing a user with data defining imagecontent at a resolution that may be determined by the user

(76) Inventors: James Henry Arbeiter, Hopewell, NJ (US); Roger Frank Bessler, Lawrenceville, NJ (US); David Fisher Reifsnyder, Mendham, NJ (US)

Correspondence Address: GEORGE J. SELIGSOHN, 9367-E SOUTHWEST 83 AVENUE, OCALA, FL, 34481, US

(21) Appl. No.: 10/095,748

(22) Filed: Mar. 13, 2002

(51) Int. Cl. H04N 7/173; H04N 7/12; H04N 11/02; H04N 11/04

(52) U.S. Cl. 348/384.1; 348/398.1; 348/437.1; 348/438.1; 725/90

(57) ABSTRACT

A user having a certain channel-bandwidth access to an interactive digital network, such as the internet, uploads control data to an allotted multiresolution data processor of a server system that downloads, to the user image content (e.g., a motion picture requested by the user) data, which may be statistically compressed. While the server system supplies the requested content as an input to the multiresolution data processor in uncompressed form at highest, spatial, temporal and color resolutions, the multiresolution data processor calculates the downloading bit rate and reduced spatial, temporal and/or color resolutions of the downloaded content in accordance with the uploaded control data from the user that defines the user's channel bandwidth and may also define the user's desired lower spatial, temporal and/or color resolutions. Intranet, cable and peer-to-peer interactive digital networks that permit a user to upload control data to control the downloading bit rate and/or reduced spatial, temporal and/or color resolutions are also disclosed.

### BACKGROUND

1. Field of the Invention

This invention relates to an interactive network, such as the wired or wireless internet, an intranet or a digital cable network, for forwarding image content, in real time, from a content provider to a particular computer or television user over the network a stream of specific image data requested by this particular user and, more particularly, the case in which the spatial, temporal and/or color resolution with which this image data is forwarded to this particular user is able to be under the control of this particular user.

2. Description of the Prior Art

Known in the art are several streaming protocols for delivery of stored media content, including video, audio, text, and graphics from a Web Server to users over networks like the internet or an intranet. Also known in the art are interactive cable networks for delivering from the cable provider to a particular user a given motion picture selected by this particular user from a library of different motion pictures available from the cable provider.

One such known streaming protocol employed by the internet is HTTP (HyperText Transfer Protocol), wherein when a client (user) requests a certain media type, a message is sent to the server and the server responds with the content. Because of the packetized mechanics of the protocol, where data is broken into small packets of information and sent independently and reconstructed into the full message at the receiver, the content is subjected to the typical occurring collision and intermittent delivery under network bandwidth congestion. In other words, this protocol does not guarantee a continuous stream of the content and, therefore, is subject to broken audio streams, jitter, and slow image reception. HTTP is the protocol used in normal data delivery over the internet.

Another such known streaming protocol is RTSP (Real Time Streaming Protocol) which was created to overcome the above-described problems which plague real-time data messages. RTSP attempts to create a ‘more dedicated’ channel for content to be delivered to one or more viewers simultaneously, and also random accesses to the stream. In RTSP, a fraction (8-15%) of the content is buffered at the client user prior to the video being played back. It is assumed that subsequent data will be received before this buffer is exhausted, thereby maintaining a continuous flow of content to the display or audio system. In RTSP the server/client control process is similar to HTTP; that is, the user issues a request to the server and the server responds with the content.

The content and applications using that content now available over the internet has grown quite large. This has necessitated a new type of server called the Media Server. A Media Server has special capabilities for accessing and delivering audio and video content. In typical operation two forms of streaming comprising Unicasting and Multicasting are used. In Unicasting each client on the network can request its own content stream, and the server will set up a stream of that content for that client alone. Other clients can likewise access the media server choosing either similar or different content. In Unicasting, once the server has exhausted its ports with one-to-one connections others cannot access the server. Routers are devices that redistribute one stream to many and thus are used to ‘widen’ the effective usage of the content among many clients.

Multicasting is analogous to broadcast television where the same content is sent to many users at one time. This mode is facilitated by using a router to dispense the content across multiple users. But now users have less freedom in choosing content to be delivered when and how they want it.

As known, content is not stored and delivered in its raw acquired form. This would consume far too much data. Instead, there are several standard video statistical compression technologies like MPEG2, MPEG4, JPEG, MJPEG, RealStream, QuickTime, and lesser knowns, and also audio compression technologies like MP3 for content transmission. Each attempts to remove data redundancies within the sequence. In video, typical compression's of 30-60:1 allow networks to move small files (usually one to two minutes) without too much wait. Even so, motion pictures viewed at some resolution are beyond what a 56 k dial-in internet channel can handle. These types of content delivery are restricted to higher bandwidth network channels like cable, and some DSL services.

In all cases of present-day content delivery, it is the content provider that has complete control of content management over the internet or cable. In the prior art, the only information from a particular user that may be communicated to the content provider is that pertaining to that particular user's maximum available channel bandwidth (e.g., the speed of the modem being used by that particular user). Further, the content management is static in that content is stored on a server, or a media server, in one or more formats available for downloading depending on the actual channel bandwidth a user has. For example, for a 56 k dial-in connection a user would elect the 56 k version, where the content has been pre-processed to fit the limitations of a 56 k channel. What this means is that the content may be limited in frame rate (like 6 frames/sec instead of 30), spatial resolution (like 80×60 instead of 320×240), and color resolution like 8-bit (i.e., 256 values) color, instead of 24-bit ((i.e., 16,777,216 values) RGB color. These resolution reductions are made a priori by the provider of the content and are not subject to change. If the provider only provides one format and a user has insufficient channel bandwidth, then that user will not be able to view the content in real-time, and possibly it could take hours to download thereby discouraging the user from accessing it at all. In other cases when multiple formats are available, they may exist in non-optimal forms for the user, thereby wasting channel bandwidth and also producing a less-than-optimal visual/audio experience.

On the other hand, a user with a broadband 300 k-bit channel would receive a higher data rate version of the content (which would of course be a better quality viewing experience). This multi-format content approach has an additional huge downside in that it consumes much server storage and requires great expense to set up. Moreover, it does not allow for optimal viewing experiences since only a handful of (usually 6 to 8) format versions are available.

From the user's point of view, it would be desirable that he or she, rather than the server provider, have at least some management control of the spatial, temporal and/or color resolution of the specific content he is requesting the server provider deliver. For a first instance, consider a user of a small hand-held display may request that the streaming data delivered by the provider be only sufficient to support the relatively low spatial resolution capability of the small hand-held display. For a second instance, consider a user requesting streaming data defining a still medical image over a hospital intranet that requires relatively high spatial and color resolution, but no temporal resolution.

Therefore, there is a need for means for permitting each particular user to have at least some management control of the spatial, temporal and/or color resolution of the specific image content he is requesting the content provider deliver to that particular user. There is also a need (independent of the value of the channel bandwidth available to any particular user) to substantially reduce the total amount of data that a provider of a library of motion-picture content must store in order to dynamically deliver, in real time, a user-selected motion picture from the library to that particular user at a spatial, temporal and or color resolution that may be determined, at least in part, by that particular user.

Incorporated herein by reference are the teachings of (1) U.S. Pat. No. 5,355,328 entitled “Resampling Apparatus Suitable For Resizing a Video Image”, (2 U.S. Pat. No. 6,295,322 entitled “Processing Apparatus for Synthetically Extending the Bandwidth of a Spatially-Sampled Video Image” and (3) co-pending U.S. patent application Ser. No. 09/591,702 entitled “Digital Processing Apparatus For Variable Image-Size Enlargement With High-Frequency Synthesis” (wherein two of the three applicants of the present application are also the applicants of the aforesaid co-pending U.S. patent application). Further, incorporated herein by reference is the teaching set forth in “Graphics File Formats”, by C. Wayne Brown and Barry J. Shepherd pp. 109-131, published by Manning Publications Co. in 1995. All of these teachings may be employed in the implementation of the present invention.

### SUMMARY OF THE INVENTION

Relates to an improvement in an interactive digital network that is responsive to control data from a particular user terminal that has been uploaded to a media-content provider, in which a stream of data defining certain image content from the media-content provider is downloaded to the particular user terminal for display of the certain image content thereat. In accordance with the improvement, (1) the certain image content is available at the media-content provider in its relatively highest-resolution form as content data and the uploaded control data defines the channel bandwidth available for downloading the stream of data, and (2) the media-content provider comprises multiresolution data processing means responsive to the uploaded control data being applied as a first input thereto and the content data being applied as a second input thereto for deriving in real time the downloaded stream of data defining the certain image content at a certain calculated resolution value equal to or smaller than the relatively highest-resolution form that is determined in accordance with a resolution value or absence thereof included in the uploaded control data applied as the first-input thereto and a resolution value of the high-resolution content data applied as the second-input thereto.

### BRIEF DESCRIPTION OF THE DRAWING

FIG. 1 is a simplified functional block diagram of a prior-art interactive communication path between a user computer terminal and the server system of a given internet media content provider selected by the user for use in delivering to the user specific media content selected by the user;

FIG. 2 is a diagram showing the 3-dimensional (3D) resolution space (i.e., spatial, temporal and color) of data defining digital moving images that are to be communicated as a data stream over the internet to the user computer terminal of FIG. 1;

FIG. 3 is a simplified functional block diagram of a prior-art first embodiment of the content-provider server system shown in FIG. 1, that in response to a request received from a user terminal is capable of serving requested stored media content to that user terminal of the internet at a resolution determined solely by the content-provider server system;

FIG. 4 is a simplified functional block diagram of a second embodiment of the content-provider server system shown in FIG. 1 employing the principles of the present invention, that in response to a request received from an internet user terminal is capable of serving requested stored media content to that internet user terminal at a resolution determined at least in part by spatial, temporal and/or color desired resolution command values received by the internet content-provider server system from that user terminal;

FIG. 5a is a simplified functional block diagram of a preferred embodiment of any one of the multiresolution data processors shown in FIG. 4 that employs statistical compression means;

FIG. 5b is a simplified functional block diagram of statistical decompression means that cooperates with the statistical compression means shown in FIG. 5a and may be employed in the user computer display of the user terminal shown in FIG. 1;

FIG. 6a is a simplified functional block diagram of a prior-art spatial-size reduction mans that may be employed in the content multiresolution processing means shown in FIG. 5a;

FIG. 6b is a simplified functional block diagram of a prior-art spatial-size expansion mans that may be employed in the user computer display of the user terminal shown in FIG. 1;

FIGS. 7a and 7b, taken together, show a flow chart of a software program for controlling the spatial, color and temporal resolution functions and statistical-compression functions performed by the embodiment of the content-provider server system shown in FIGS. 4, 5a and 6a;

FIG. 8 is a simplified functional block diagram of a prior-art interactive cable system that permits any television-user terminal to employ the cable channel to select particular digital video content stored in the video-on-demand library of the cable-provider's stored digital content terminal; and

FIG. 9 is a simplified functional block diagram of an interactive peer-to-peer network that may embody the present invention.

### DESCRIPTION OF THE PREFERRED EMBODIMENTS

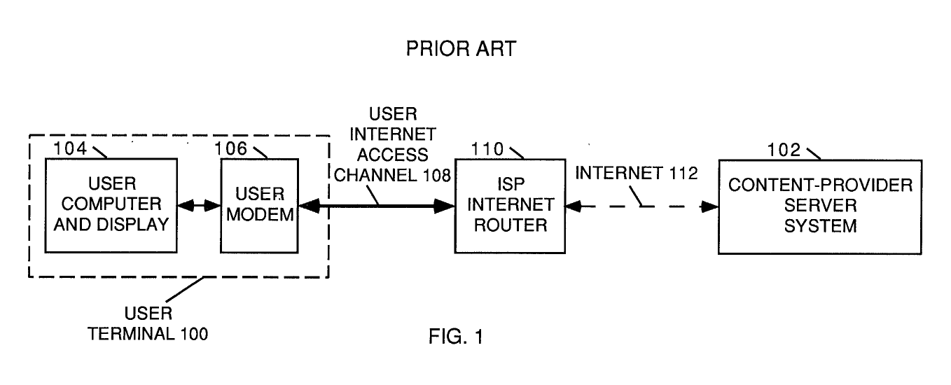

Referring to FIG. 1, there is shown user terminal 100 that has interactive access over the internet to content-provider server system 102. More particularly, as known in the prior art, user terminal 100 comprises user computer and display 104 and associated user modem 106. User computer and display 104 may include memory means for storing software programs and applications that are needed to gain access to the internet, together with a keyboard or keypad which permits the user to directly enter data to be transmitted over the internet. User modem 106 is capable of transmitting data between computer and display 104 and user internet access channel 108 at a baud speed determined by user modem 106. For instance, for use with a conventional narrow-bandwidth telephone dial-up copper-wire user internet access channel 108, the baud speed of user modem 106 may be as low as 1200 bauds and as high as 56 kilobauds. However, for a relatively broadband cable or DSL user internet access channel 108, the baud speed of user modem 106 may be several hundreds of kilobauds, while for a fiber-optic user internet access channel 108, the baud speed of user modem 106 may be a megabaud or more. In some cases, such as cable for instance, user internet access channel 108 is shared among a plurality of user terminals. In any event, data is communicated over user internet access channel 108 between user terminal 100 and ISP (internet service provider) internet router 110.

As known in the prior art, the data uploaded to internet router 110 from user terminal 100 (which may or may not have been modified by the ISP) would include such items as the address of user terminal 100, the address of the particular internet web-site being called, the identity of the content at that website being requested to be downloaded to user terminal 100. This uploaded data is available either directly from software stored in user computer and display 104 or from a data entry by the user of computer and display 104. Further, the data uploaded to internet router 110 may also include information as to the bandwidth of user internet access channel 108 and the baud speed of user modem 106. As is further known, internet router 110 is capable of (1) packetizing the data uploaded over user internet access channel 108 and forwarding these packets over internet 112 to content-provider server system 102 of the called web site, and (2) downloading requested-content data packets from content-provider server system 102 to internet router 110, where the downloaded requested-content data packets are depacketized into a data stream that is forwarded back over user internet access channel 108 to user terminal 100. This permits the stream of downloaded requested-content data to be applied as an input to user computer and display 100 so that, for use in most applications, it is able to be visually displayed on the screen of user computer and display 100. In practice, the size of the screen of user computer and display 100 may vary from the very small size of a hand-held computer display screen, to that of a laptop or desktop computer, or even the screen a large projection display. The effective image resolution capabilities of these different size screen displays from a viewer's point of view varies considerably.

In general, the downloaded requested-content data may represent text, audio and images (including both still images and moving-picture images). However the present invention is limited to improvements over the prior art which permit any user computer and display 104 to display on the screen of its user computer and display 104 a still image or the successive images defining a motion-picture at a desired spatial, temporal and/or color resolution. In accordance with the principles of the present invention, the software stored in user computer and display 104 and/or the data entry by the user of computer and display 104, for use in uploading data to content-provider server system 102, further includes control data defining the desired spatial, temporal and/or color resolution. In response thereto, content-provider server system 102 downloads to user terminal 100 a data stream defining the requested still or motion-picture images at a spatial, temporal and/or color resolution determined, at least in part by the uploaded control data.

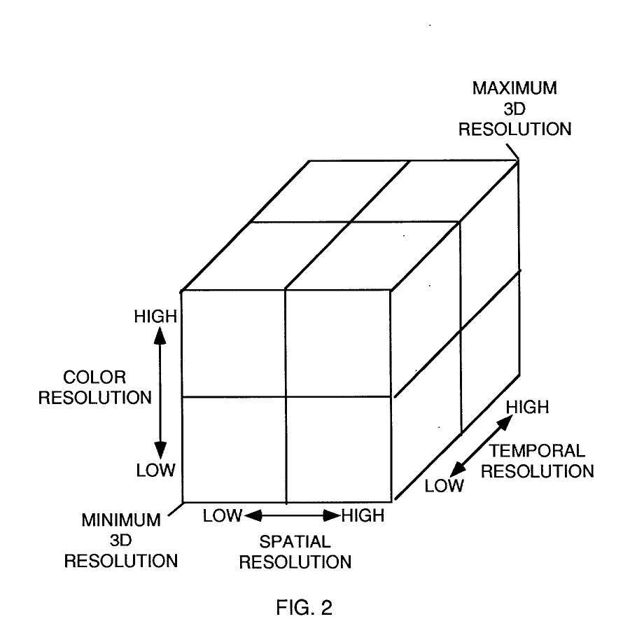

Each point of the 3D resolution space of FIG. 2 (which extends from the minimum 3D resolution point at the bottom left to the maximum 3D resolution point at the top right) defines a different combination of (1) spatial-resolution value of a frame, (2) temporal-resolution value (i.e., frame rate) and (3) color-resolution value of moving-picture data to be downloaded as a data stream to user computer and display 104 over the communication path comprising internet 112, router 110 access channel 108 and modem 106. Spatial resolution it self is 2 dimensional (2D), comprising, respectively, the horizontal and vertical resolutions of each frame of the moving image data, while temporal resolution comprises the frame rate of the moving image data. Color resolution, in the case of monochrome, comprises gray-scale resolution. The desired resolution for each of the spatial, temporal and color resolutions is determined by a separate group of uploaded data bits from user terminal 100. For instance, the uploaded data must request a 24-bit color resolution for downloaded image data, if the user desires a high RGB color resolution with each of red, green and blue color components being quantized to 256 different intensity levels. However, should the user be satisfied a downloaded monochrome image limited to only black and white colors, the uploaded data need request only a 1-bit color resolution for downloaded image data,

Further, if the 3D resolution of the moving-picture data (either statistically compressed or uncompressed) is close to the maximum and the communication path is broadband (e.g., sable or DSL), the data stream can be downloaded in a relatively short period of time. However, in the case of a shared broadband communication path, the simultaneous downloading of several high 3D resolution moving-picture data streams leads to congestion, which is a disadvantage. Further, it takes an inordinately long period of time to download such high 3D resolution moving-picture data over a narrowband communication path is (e.g., dial-up path) and store the downloaded data stream at user computer and display 104, which is also a disadvantage.

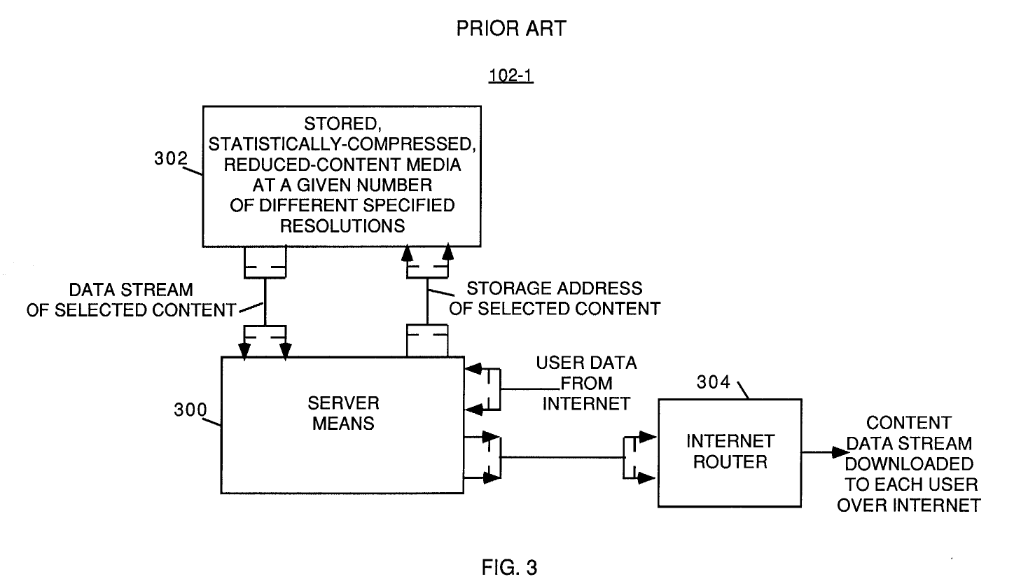

Referring now to FIG. 3, there is shown the approach taken by the prior art in downloading requested media data as a data stream from content provider server system 102 to the user computer and display 100 of any one of a plurality of the user terminals 100. Specifically, FIG. 3 comprises server means 300 (which is intended to include a web server, a media sever and associated control means), which, in response to uploaded user data, received over the internet from each individual one of a plurality of users (1) allots a separate server to that individual user, (2) supplies a storage address of selected media content to stored, statistically-compressed, reduced-content media at a given number of different specified resolutions 302 in accordance with both the limited uploaded user data from that individual user (which relates solely to the identity of his or her requested motion picture, and his or her access channel 108 bandwidth and modem 106 baud speed) and other control data that server means 300 may have available, and (3) forwards the data stream of the selected compressed content from block 302 to internet router 304, which packetizes the selected data stream with appropriate header data to download the data stream of requested media content to the user terminal 100 of that individual user. As known in the prior art, user computer and display 104 may comprise decompression software for decompressing the selected compressed content before it is displayed by user computer and display 104.

As an illustrative example of the prior-art embodiment of FIG. 3, it is assumed that, for purposes of video-on-demand, block 302 stores a large library (e.g., 200) different motion pictures, each of which already has been statistically compressed at each of 6 to 8 or even more different degrees of resolution. Server means 300 downloads to the user terminal 100 of each user the data stream of the motion picture requested by the uploaded user data from that user at a certain one of the available specified resolutions which is within the bandwidth of access channel 108 and baud speed of modem 106 of that user. A first problem in this prior-art example is that the required storage capacity of block 302 is huge and the cost of precompressing at each different degree of resolution each of such a large library of motion pictures is also very large. A second problem is that the specified resolution of the downloaded motion picture to a user terminal 100 with a relatively large-screen computer and display 104 of a user may be substantially below the bandwidth of access channel 108 and baud speed of modem 106 of that user. In this case, the viewed picture quality is reduced below that it could have been if substantially all the bandwidth of access channel 108 and baud speed of modem 106 of that user were employed. A third problem is that the specified resolution of the downloaded motion picture to a user terminal 100 with a relatively small-screen computer and display 104 (e.g., the screen of a hand-held display device) of a user may be substantially greater than is able be resolved by a viewer of such a small display screen. In this case, excessive data, which is unusable, is downloaded, thereby contributing to data congestion occurring over the internet communication path from the prior-art first-embodiment of server system 102-1, shown in FIG. 3, to the user terminal 100 of any user.

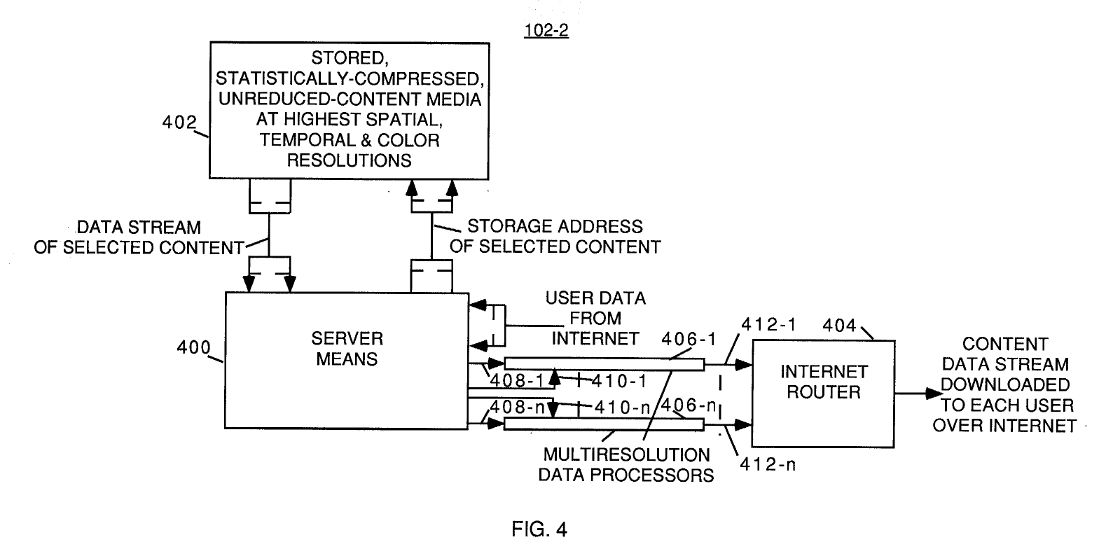

All these problems are eliminated or, at least, minimized by employing the second embodiment of server system 102-2, shown in FIG. 4, which incorporates the teachings of the present invention. In FIG. 4, server means 400, like server means 300, include a web server, a media sever and associated control means. However, the user data from internet received from each user terminal 100 and applied as an input to server means 400 includes uploaded data defining the spatial, temporal and/or color resolution of the media content requested by that user to be downloaded to him or her. In response thereto, server means 400 (1) applies the storage address of selected content to stored, statistically-compressed, unreduced-content media at highest spatial, temporal and color resolutions 402 (where the media content is assumed to be a library of video-on-demand motion pictures), (2) in response thereto has the data stream of the selected content applied as an input to server means 400. It should be understood that different ones of the stored unreduced-content media may have different values of highest-spatial, temporal and/or color resolutions, while the degree of statistical-compression for each separate one of these unreduced-content media is sufficiently small so that upon being statistically-decompressed there is very little, if any, loss in resolution of the content. Preferably, prior to being statistically compressed and stored, each different one of the unreduced-content media includes a header defining the respective values of highest-spatial, temporal and/or color resolutions of that particular unreduced-content media (which header is statistically compressed and stored in block 402 along with that particular unreduced-content media). Further, FIG. 4 comprises a group of multiresolution data processors 406-1 to 406-n, each of which may be allotted by server means 400 to a separate internet user. Server means 400 forwards for processing the data stream of the content selected by a user as a content input 408-1 to 408-n to that one of multiresolution data processors 406-1 to 406-n that has been allotted to that user. In addition, server means forwards uploaded data requested by a user to that one of control inputs 410-1 to 410-n associated with the multiresolution data processor 406-1 to 406-n allotted to that separate internet user. This forwarded uploaded data defines the spatial, color and/or temporal resolution of the media content and may also define the degree of statistical compression desired by the user for the processed content to be downloaded to that user. The processed data output 412-1 to 412-n from each of allotted multiresolution data processors 406-1 to 406-n is applied as an input to internet router 404, which is effective in downloading the processed data stream to each user over the internet. All processing by any of multiresolution data processors 406-1 to 406-n is done “on the fly” in real time.

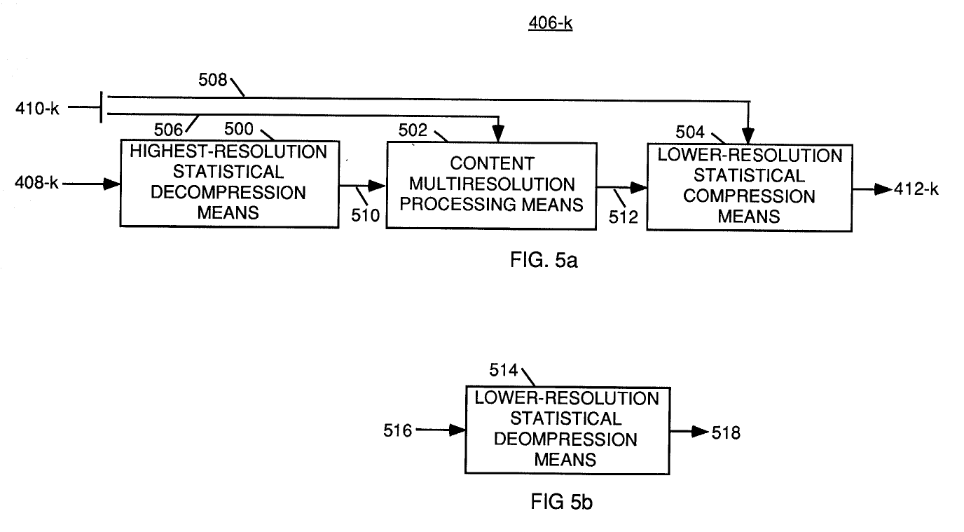

As shown in FIG. 5a, a preferred embodiment of any one multiresolution data processor 406-k comprises highest-resolution statistical-decompression means 500, content multiresolution processing means 502 and lower-resolution statistical-compression means 504. A first component of control input 410-k defining user-desired spatial, color and/or temporal resolution is applied as control input 506 to block 502; a second component of control input 410-k defining a user-chosen type of the various standard compression technologies is applied as control input 508 to block 504, and content input 408-k is applied as the content input to block 500. The uncompressed content output 510 from block 500 is applied as the content input to block 502. The resolution-processed output 512 from block 502 is applied as the content input to block 504. The user-desired statistically-compressed output from block 504 constitutes the output 412-k from multiresolution data processor 406-k.

FIG. 5b shows statistical decompression means 514 which may be included in user computer and display 104 of the user terminal 100 that receives the processed stream of content data downloaded from FIG. 5a. This downloaded processed stream of content data is applied as content input 516 to block 514, thereby deriving uncompressed output data stream 518 therefrom. As known in the prior art, statistical decompression means 506 may comprise known decompression software for decompressing the selected compressed output data stream 504.

In the embodiments shown in FIGS. 4 and 5a, the only reason that block 402 stores the unreduced content media in statistically-compressed form (which then requires statistical-decompression by block 500) is to reduce the size of storage capacity needed. However, the present invention also contemplates the cases wherein (1) the unreduced content media is stored in uncompressed form and (2) the unreduced content media is not stored, but occurs as an ongoing real-time signal in uncompressed form. In both these cases, there is no need for statistical decompression, so that block 500 in FIG. 5a can be eliminated.

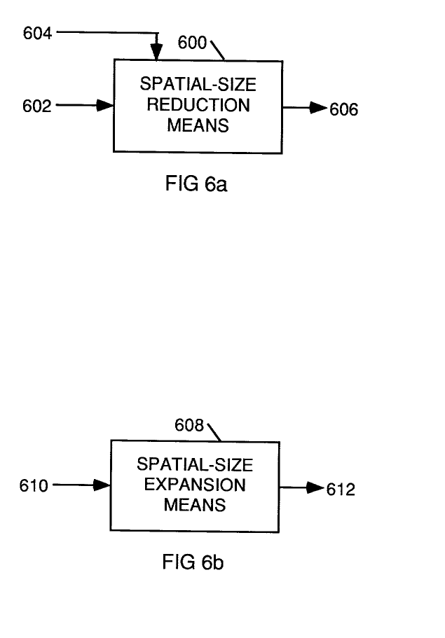

As shown in FIG. 6a, a preferred embodiment of content multiresolution processing means 502 may comprise spatial-size reduction means 600 that employs the teachings of the aforesaid U.S. Pat. No. 5,355,328 for reducing the horizontal and/or vertical spatial resolution of each frame of highest spatial resolution content data input 602 to spatial-size reduction means 600 by any specified fractional amount without introducing aliasing in accordance with control input 604 applied thereto (where control input 604 comprises, at least, a portion of control input 408-k), thereby deriving a lower spatial resolution content data output 606 from spatial-size reduction means 600 in accordance with user uploaded spatial-resolution data defined by control input 604.

If the size of the display of a user terminal 100 (that receives lower spatial resolution content data output 606 communicated from spatial-size reduction means 600) is small (e.g., the display of a hand-held device, for example), there is no need to expand the size of the received reduced spatial-size content at user terminal 100. However, where there is a need to expand the display-size of the reduced spatial-size content communicated from spatial-size reduction means 600, spatial-size expansion means 608, shown in FIG. 6b, may be included in user computer and display 104 for increasing the spatial size, by any specified fractional amount, of each reduced-size frame of the content defined by lower spatial resolution content data output 606. Specifically, spatial resolution content data output 606 is forwarded as data input 610 to means 608 to thereby derive expanded-size data output 612 therefrom. While the aforesaid U.S. Pat. No. 5,355,328 also teaches spatial-size expansion means for increasing the horizontal and/or vertical size of each expanded content frame, it does nothing to restore the spatial high-frequency components of each content frame that have been removed by spatial-size reduction means 600. However, the respective teachings of the aforesaid U.S. Pat. No. 6,295,322 and co-pending U.S. patent application Ser. No. 09/591,702 define means for synthetically introducing such spatial high-frequency components of each content frame.

The bit rate that would be required to download in real time uncompressed moving-picture content in full color is enormous. More specifically, a downloading bit rate of 55.296 megabits per second would be required to download in real time a motion picture at 30 frames per second having a spatial resolution of 320×240 pixels per frame with an RGB color depth of 24 bits per pixel. Immediate reduction of data is possible spatially using spatial resizing at the server using the teachings of the aforesaid U.S. Pat. No. 5,355,328. This amount of reduction can vary from a factor of 1 (no reduction) to k, where k is expected to practically not exceed 64. Further, employing today's prior-art MPEG compression techniques it is possible to statistically reduce the spatial-resolution data by as much as 60:1. This results in an overall data reduction of from 60 to 60 times 64 (60×1 for no spatial reduction and 60×64 for maximum spatial reduction).

Further, there are several techniques known in the prior art for reducing color resolution, in accordance with the uploaded resolution control data received from any particular user terminal 100, at the uncompressed content multiresolution processing means 500 then allotted to that particular user terminal 100. For example, 24-bit RGB is a typical color space where each color component is normally specified to 8-bit resolution. One known way is to employ look-up tables to reduce this 8-bit resolution for each R, G and B color to 6-bit or even 4-bit resolution. Another known way to reduce color resolution is to employ look-up tables to convert RGB color resolution to YUV color resolution. In YUV the Y (luminance) is updated each pixel time, while the UV (chrominance) pair is updated alternate pixel times.

Also, there are more advanced methods, which may be incorporated in any particular user terminal 100, for using a color lookup table that maps few values into values that are more appropriate for display. This offers a way to create non-linear mappings from few values into better choices. In this regard, reference is made to “Graphics File Formats”, by C. Wayne Brown and Barry J. Shepherd pp. 109-131, which disclose various color systems.

As known, temporal resolution can be reduced, in accordance with the uploaded resolution control data received from any particular user terminal 100, by dropping frames at the uncompressed content multiresolution processing means 500 then allotted to that particular user terminal 100. Dropped frames can then be restored at that particular user terminal 100 user terminal 100 by either simply repeating a previous frame or, alternatively, averaging two frames together. In a more sophisticated technique known in the prior art, content motion between successively-received frames is detected and then a new adaptively synthesized frame is interpolated in between each pair of successively-received frames.

In operation, the uploaded control data 408-1 to 408-n from each particular user applied, respectively, to an allotted one of multiresolution data processors 406-1 to 406-n comprises, at the very least, control data defining the channel bandwidth of that particular user and it may also comprise control data defining any or all of the spatial, temporal and color resolution values for the downloaded content requested by that particular user. Each allotted one of multiresolution data processors 406-1 to 406-n comprises a software program that first employs the channel-bandwidth value of the uploaded control data thereto to calculate a maximum bit rate value (i.e., the number of bits per second) that still remains within this channel bandwidth to download, in real time, the user-requested content. Should the channel-bandwidth uploaded control data be the only uploaded control data, the software program follows a priority of resolution tradeoffs as a default to achieve spatial, temporal and color resolutions for the downloaded content data that conform with the calculated maximum bit rate value. However, should the uploaded control data also define any or all of the spatial, temporal and color resolution values for the downloaded content requested by that particular user and show that these requested resolution values can be achieved at a downloading bit rate that is equal to or less than the calculated maximum bit rate, the software program employs these uploaded requested resolution values to download selected content to that particular users computer and display 104 to effect a display of the spatial, temporal and/or color resolution specified by; the uploaded requested resolution values. On the other hand, should these requested resolution values be achievable only at a downloading bit rate that exceeds the calculated maximum bit rate, the software program modifies the requested resolution values in accordance with prioritized tradeoffs to effect those values for the content spatial, temporal and color resolution that are able to be downloaded to that particular user at the aforesaid maximum bit rate.

It is apparent from the 3D resolution space shown in FIG. 2 that the same value of the overall 3D resolution of a downloaded motion picture may be achieved with various combinations of spatial-resolution value, temporal-resolution value and color-resolution value. The priority tradeoffs in choosing the relative amount of weight to be given to each of these three resolution values (when not determinable by uploaded resolution-value data from a user) is determined by the content provider. For example, it can be assumed that making the image smaller would greatly reduce data bandwidth. Following that it is possible that a reduction in the color depth would still allow a reasonable video experience. After that, complete images (frames) can be dropped from the sequence.

In any case, as known in the art, the downloaded data stream over the internet incorporates “headers” that provide address and other control data. In accordance with the present invention, this header data includes the respective actual values of spatial, color and temporal resolution values employed by the downloaded content, whether or not these actual values are or are not the same as those values of the user-requested spatial, temporal and color resolution defined by the uploaded control data received from a user terminal 100. These respective actual values of spatial, temporal and color resolution values, therefore, are available to a user computer and display 104 receiving a downloaded stream of content data for determining the spatial, temporal and color resolution of the displayed motion-picture content.

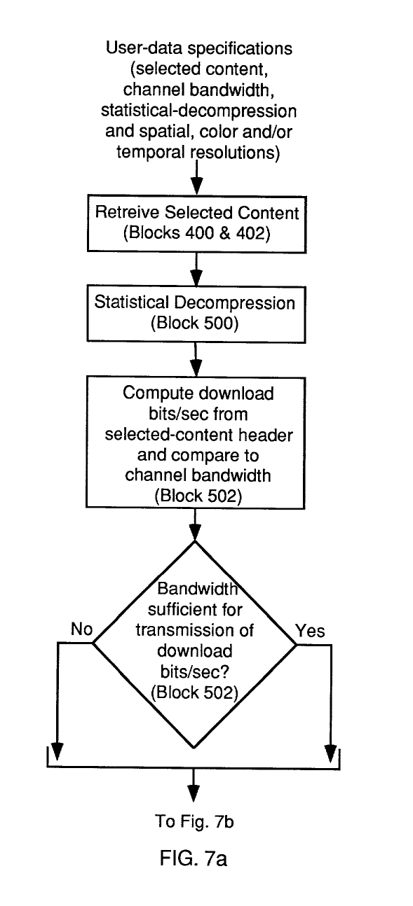

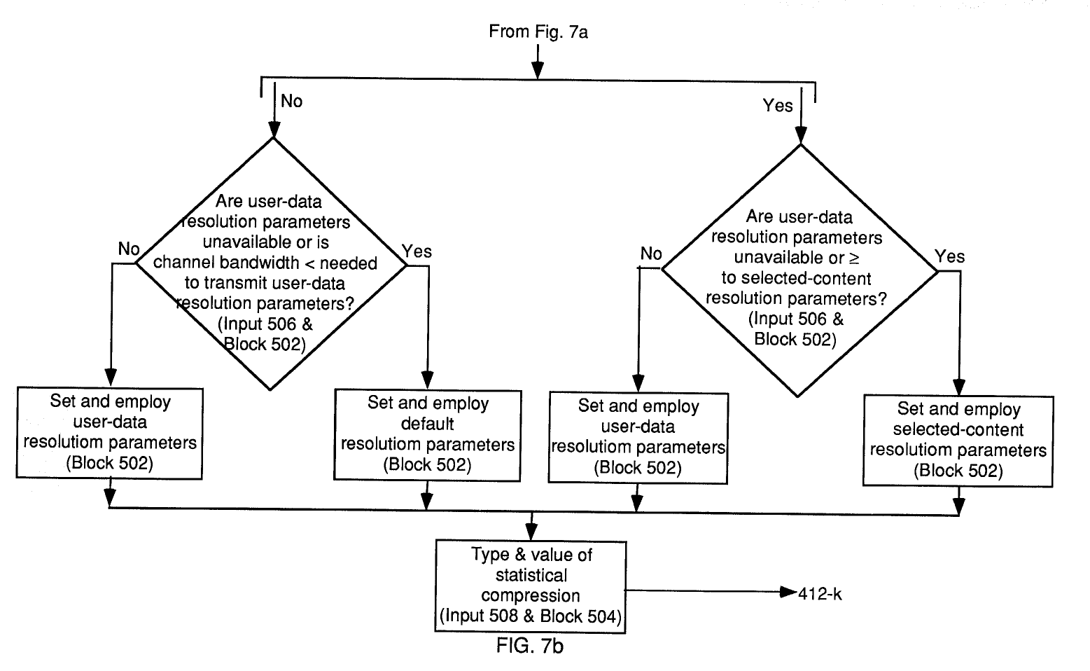

The present invention preferably employs the software program defined by the flow chart shown in FIGS. 7a and 7b, taken together, to determine the respective actual values of spatial, color and temporal resolution values employed by the downloaded content. Specifically, this is done by controlling the resolution functions performed by the embodiment of the content-provider server system shown in FIGS. 4, 5a and 6a in the manner shown in this flow chart. In addition, the flow chart also includes the control of the type of the statistical-compression function performed by the lower-resolution statistical compression means shown in FIG. 5a.

The information supplied to a content multiresolution processing means 502 then allotted to a particular user includes, at least, (1) the respective header values of the spatial, color and temporal resolutions of that one of the unreduced content media (e.g., particular motion picture) selected by that particular user and (2) the available channel bandwidth for downloading this the selected content media to that particular user. The information supplied to a content multiresolution processing means 502 then allotted to that particular user may also include supplied user-data defining the respective values of the desired spatial, color and temporal resolutions. As indicated in the FIGS. 7a and 7b flow chart, the software program included in content multiresolution processing means 502 first employs these header values to compute the value of the bits/sec required to download the unreduced content media in real time to the particular user and then compares this computed value of bits/sec to the available channel bandwidth. Further, the software program employs logic means responsive to this comparison and the desired values of spatial, color and temporal resolutions supplied by that particular user (if available) for determining the spatial, color and temporal resolutions of the selected content media that, after being statistically-compressed by means 504, is downloaded over the available bandwidth to this particular user (where the value of the statistical-compression factor is sufficiently low as to not materially affect the spatial, color and temporal resolutions of the displayed content after statistical decompression by means 514 at the particular user's terminal).

Specifically, if the comparison shows that the available channel bandwidth is sufficient to handle the computed value of bits/sec and user-data resolution parameters are either unavailable or request spatial, color and temporal resolutions greater than those defined by the respective header values, the spatial, color and temporal resolutions defined by the respective header values are employed for downloading the selected media to the particular user. However, if the comparison shows that the available channel bandwidth is sufficient to handle the computed value of bits/sec, but the user-data resolution parameters request spatial, color and temporal resolutions smaller than those defined by the respective header values (which may be the case when the user's display is part of a hand-held device or is otherwise of small size), the spatial, color and temporal resolutions defined by the user-data resolution parameters are employed for downloading the selected media to the particular user. On the other hand, if the comparison shows that the available channel bandwidth is insufficient to handle the computed value of bits/sec, but is sufficient to handle the spatial, color and temporal resolutions requested by the user-data resolution parameters are employed for downloading the selected media to the particular user. However, if the comparison shows that the available channel bandwidth is insufficient to handle the computed value of bits/sec, but the user-data resolution parameters are unavailable, a set of default values of spatial, color and temporal resolutions are derived by content multiresolution processing means 502 which default values are sufficiently low to permit the available channel bandwidth to be able to download the selected content in real time. Preferably, these default values of resolutions are derived by look-up tables, in which the particular value of channel bandwidth available to any particular user is used to derive a set of relatively high resolution default values for the downloaded selected content that makes use of nearly all of this available channel bandwidth.

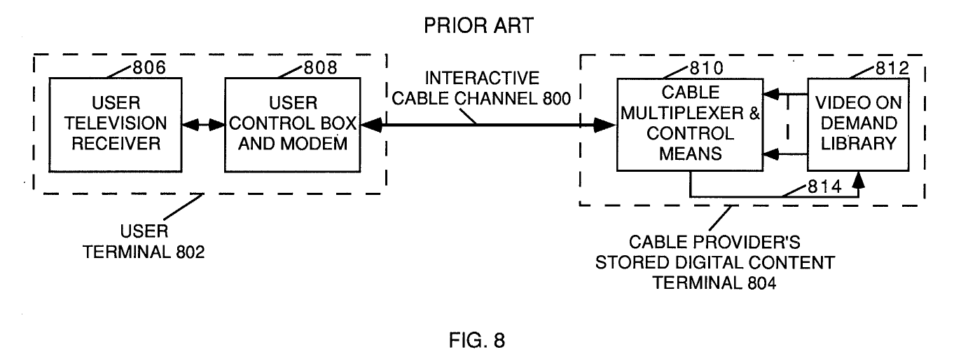

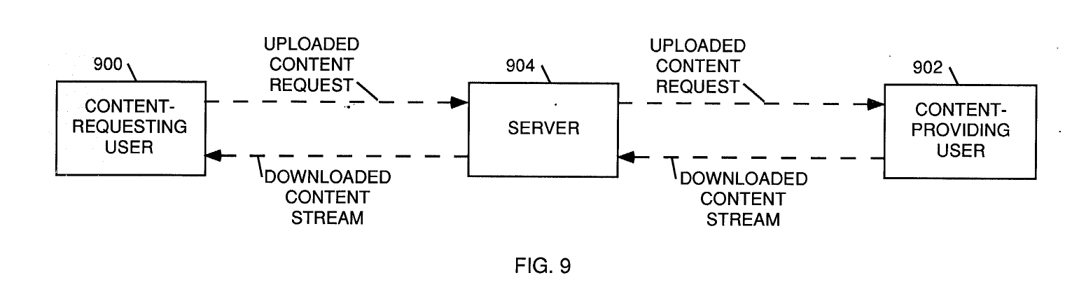

The present invention is not limited to an interactive network that incorporates the internet (as specifically shown in FIGS. 1 and 4). It is apparent that an interactive intranet network could be substituted for the above-described internet network without in any way altering the principles of the present invention. In addition, the present invention may be advantageously embodied in an interactive cable network (such as shown in FIG. 8) providing video-on demand or in an interactive peer-to-peer network (such as shown in FIG. 9) which permits a first user to upload requested content data to a second user and the second user to download a stream of the requested content data to the first user.

Referring to FIG. 8, there is shown a type of cable network known in the prior art comprising broadband interactive cable channel 800 for associating any of a plurality of user terminals such as user terminal 802, having access to channel 800 with cable provider's stored digital content terminal 804. User terminal 802 comprises user television receiver 806 and user control box and modem 808 (where the user control box may be a set-top box provided the user by the cable provider). Cable provider's stored digital content terminal 804 comprises cable multiplexer and control means 810 and video-on-demand library 812 including a plurality of stored motion pictures. In the prior art, library 812 stores each motion picture in already compressed data form, while a user employs his or her control box and modem 808 to upload his or her address and the identity of a requested motion picture to cable multiplexer and control means 810, which then forwards the identity of the requested motion pictures as control input 814 to library 812. In response thereto, cable multiplexer and control means 810 downloads a data stream of the requested motion picture to the requesting user's control box and modem 808. After being decompressed, the requested motion picture is displayed on the screen of that user's television screen 806. Since cable channel 800 is broadband, there is no need for library 812 to store each motion picture at a given number of different specified resolutions (as in the prior-art internet case shown in FIG. 3). However, each of many users may have the respective data streams of their requested motion pictures simultaneously downloaded to them and many of these motion pictures (particularly in the future) may be high-definition motion pictures.. This leads to undesirable congestion of the total amount of data being downloaded over cable channel 800. This undesirable congestion can be eliminated, or at least minimized, by structurally and functionally modifying user terminal 802 and cable provider's stored digital content terminal 804 in accordance with the above-described teachings of FIGS. 4, 5a, 5b, 6a and 6b. More specifically, (1) video-on-demand library 812 would store the data defining each motion picture in statistically-compressed form at highest spatial, temporal and color resolution, (2) user terminal would upload control data of desired reduced spatial, temporal and/or color resolution, (3) cable multiplexer and control means includes a multiresolution data processor (which preferably includes statistical compression means) responsive to the desired reduced spatial, temporal and/or color resolution uploaded control data that operates in real time to effect a reduced stream of data defining the requested motion picture being downloaded to user terminal 802 for further processing by user control box 808, if desired by the user, and display on user television receiver 806.

Referring to FIG. 9, there is shown a peer-to-peer network, known in the prior art, which permits any one of a plurality of users operating as a content-requesting user, such as content-requesting user 900, to upload content-request data over the network to another one of the plurality of users operating as a content-providing user, such as content-providing user 902, by means of server 904 operating as a switching device that, in response to address control data uploaded to server 904 by content-providing user 902, completes an interactive connection between content-requesting user 900 and content-providing user 902. In response to the received uploaded content-request data, content-providing user 902 downloads a stream of content data over this connection to content-requesting user 900. The above-described teachings of the present invention may be incorporated in the peer-to-peer network shown in FIG. 9. More specifically (1) content-providing user 902 has particular motion-picture content available that is initially in statistically-compressed form at highest spatial, temporal and color resolution, (2) server 904 may include a directory of motion-picture content from content-providing user 902 which could then be used by content-requesting user 900 to upload his or her content-request data along with control data defining his or her channel bandwidth and, preferably, his or her desired reduced spatial, temporal and/or color resolution to content-providing user 902, (3) content-providing user 902 includes a multiresolution data processor (which preferably includes statistical compression means) responsive to the desired reduced spatial, temporal and/or color resolution uploaded control data that operates in real time to effect a reduced stream of data defining the requested motion picture being downloaded to content-requesting user 900 for further processing by content-requesting user 900, if desired by that user.

In addition to motion-picture image content, the present invention is also suitable for a user who needs to control the spatial and color resolution of a displayed still picture supplied to him or her over the internet or an intranet. An example would be a hospital intranet capable of delivering a requested diagnostic x-ray from a library of stored x-rays for display.

What is claimed is:

1. In an interactive digital network, responsive to control data from a particular user terminal having been uploaded to a media-content provider, for downloading a stream of data defining certain image content from said media-content provider to said particular user terminal for display of said certain image content thereat, the improvement wherein:
said certain image content is available at said media-content provider in its relatively highest-resolution form as content data and said uploaded control data defines the channel bandwidth available for downloading said stream of data; and
said media-content provider comprises multiresolution data processing means responsive to said uploaded control data being applied as a first input thereto and said content data being applied as a second input thereto for deriving in real time said downloaded stream of data defining said certain image content at a certain calculated resolution value equal to or smaller than said relatively highest-resolution form that is determined in accordance with a resolution value or absence thereof included in said uploaded control data applied as said first-input thereto and a resolution value of said high-resolution content data applied as said second-input thereto.

2. The interactive digital network defined in claim 1, wherein said multiresolution data processing means comprises:
content multiresolution processing means responsive to said uploaded control data being applied as a first input thereto and said certain image content in its relatively highest-resolution form being applied as a second input thereto for deriving in real time an output therefrom; and
statistical compression means having said output from said content multiresolution processing means applied as an input thereto for deriving in real time a statistically-compressed stream of data having a certain value of compression as an output therefrom, said statistically-compressed stream of data constituting said downloaded stream of data.

3. The interactive digital network defined in claim 2, wherein:
said uploaded control data from said particular user terminal includes control data defining said certain value of compression which is applied as a control input to said statistical compression means; and
said particular user terminal comprises statistical decompression means providing an amount of decompression which is the inverse of said certain value of compression.

4. The interactive digital network defined in claim 2, wherein:
said downloaded stream of data comprises header data defining said certain value of compression; and
said particular user terminal comprises statistical decompression means providing an amount of decompression in accordance with said header data defining the compression value.

5. The interactive digital network defined in claim 1, wherein:
said uploaded control data from said particular user terminal includes control data defining at least one of the respective spatial, temporal and color resolution values desired by that particular user terminal for said downloaded stream of data defining said certain image content; and
said multiresolution data processing means employs said uploaded control data defining at least one of the respective spatial, temporal and color resolution values for calculating said resolution value of said downloaded stream of data defining said certain image content.

6. The interactive digital network defined in claim 5, wherein:
said uploaded control data from said particular user terminal includes control data defining said spatial resolution value desired by said particular user terminal; and
said multiresolution data processing means comprises spatial-size reduction means responsive to said spatial resolution value desired by said particular user terminal for calculating a resolution value of said downloaded stream of data defining said certain image content which defines a reduced spatial-resolution value.

7. The interactive digital network defined in claim 6, wherein:
said downloaded stream of data comprises header data defining said reduced spatial-resolution value; and
said particular user terminal comprises spatial-size expansion means providing an amount of spatial expansion in accordance with said header data defining said reduced spatial-resolution value.

8. The interactive digital network defined in claim 1, wherein:
said uploaded control data does not define any of the respective spatial, temporal and color resolution values to be calculated by said multiresolution data processing means; and
said multiresolution data processing means comprises a given software program for calculating respective spatial, temporal and color resolution values on a certain priority of tradeoff basis for said calculated resolution value of said downloading a stream of data.

9. The interactive digital network defined in claim 1, wherein said media-content provider comprises:
media storage means for storing a plurality of image content, each of which is in its relatively highest-resolution form;
a plurality of multiresolution data processors; and
server means responsive to uploaded control data received over said interactive network from any one of a plurality of user terminals for (1) allotting one of said plurality of multiresolution data processors for use by that one of said plurality of user terminals, (2) forwarding a selected one of the plurality of image content as said second input from said media storage means to said allotted one of said plurality of multiresolution data processors, and (3) forwarding said uploaded control data from that one of said plurality of user terminals as said first input to said allotted one of said plurality of multiresolution data processors for deriving in real time a downloaded stream of data defining said selected one of the plurality of image content at said calculated resolution value determined in accordance with values defined by said uploaded control data applied as said first-input thereto

10. The interactive digital network defined in claim 9, wherein:
said media storage means comprises means for storing each of said plurality of image content in statistically-compressed form; and
each of said plurality of multiresolution data processors includes means for statistically-decompressing said selected one of the plurality of image content forwarded thereto.

11. The interactive digital network defined in claim 10, wherein:
said interactive network comprises the internet.

12. The interactive digital network defined in claim 9, wherein:
said interactive network comprises the internet.

13. The interactive digital network defined in claim 1, wherein:
said interactive network constitutes a cable network;
said media-content provider comprises (1) a video-on-demand library of motion-picture data in uncompressed form at highest spatial, temporal and color resolution and (2) cable multiplexer and control means that includes said multiresolution data processing means; and
said user terminal comprises a television receiver and a user control box and modem for uploading to said cable multiplexer and control means first control data defining a requested a video-on-demand motion picture from said library and second control data defining desired reduced spatial, temporal and/or color resolution values for display of said requested motion picture;
thereby resulting in said multiresolution data processing means effecting said requested motion picture being downloaded to said user terminal for display on said television receiver at reduced spatial, temporal and/or color resolution values in accordance with values defined by said uploaded control data.

14. The interactive digital network defined in claim 1, wherein:
said interactive network constitutes a peer-to-peer network in which said particular user terminal comprises a content-requesting user terminal, said media-content provider comprises a content-providing user terminal and a server incorporating switching means responsive to control data applied thereto from said content-requesting user terminal completes a connection over said network between said content-requesting user terminal and said content-providing user terminal;
said certain image content is available at said content-providing user terminal in its relatively highest-resolution uncompressed form; and
said content-providing user terminal includes said multiresolution data processing means responsive to said uploaded control data being applied thereto for deriving in real time said downloaded stream of data defining said certain image content at said calculated resolution value smaller than said highest-resolution certain image content that is determined in accordance with values defined by said uploaded control data.
